(19) United States
(12) Patent Application Publication
(10) Pub. No.: US 2023/0024415 A1
(43) Pub. Date: Jan. 26, 2023

(54) UV LED CURING APPARATUS

(71) Applicant: NAIL ALLIANCE, LLC, Gladstone, MO (US)

(72) Inventor: Danny Lee Haile, La Habra, CA (US)

(21) Appl. No.: 17/872,251

(22) Filed: Jul. 25, 2022

Related U.S. Application Data
(60) Provisional application No. 63/225,238, filed on Jul. 23, 2021.

(51) Int. Cl. A45D 29/18; A45D 44/02; F26B 3/28

(52) U.S. Cl. CPC A45D 29/18; A45D 44/02; F26B 3/28; A45D 2200/205

(57) ABSTRACT

A UV LED curing apparatus can have an inner casing having a plurality of planes formed at a reflective angle with an outer casing detachably attached to the inner casing. The outer casing and the inner casing can define a space suitable for receiving an ultraviolet (UV) light emitting diode (LED) light source therein which can include a plurality of LED modules and at least one LED module arranged on two or more planes. An adjustable arm can be pivotally coupled with the outer casing at a proximal end and extend a predetermined distance to a distal end having a second UV LED light source including a second plurality of LED modules coupled therewith. A switch controller electrically connected to the UV LED light source and/or the second UV LED light source controlling an on-off state of the UV LED light source and/or the second UV LED light source.

### FIELD

The present invention relates to an ultraviolet (UV) curing apparatus, and more particularly, to an UV light emitting diode (LED) curing apparatus utilizing a UV LED light source for solidifying an acrylic gel.

### BACKGROUND

As solid state lighting or LED lighting is being widely adapted in various applications of lighting and is becoming one of the great solutions to a greener world. Among various types of LED, a new family of LED capable of emitting UV radiation or light in a shorter wavelength than the visible light, also known as UV LED, has been developed for industrial applications.

One major concern to the use of such UV devices with human hands or feet is the hazard of having human skin exposed to UV rays under these traditional UV lamps or bulbs of the devices for a short or long period of time that can lead to undesirable skin cancer in a long run. Such hazard is also known to be closely related to the fact that traditional UV lamps typically emit three types of UV light in reference to skin protection and these are UVA, UVB, and UVC. Among the three rays, UVC is the most damaging and is the most energetic of the three types.

Furthermore, illuminating devices utilizing high power LED module, including UV LED module, shall provide a desired illumination onto a region covering for example multiple fingers or toes all at once while preventing undesirable UV light, such that an UV hardening gel can be cured by the UV light effectively and safely.

It is desirable to provide an UV curing device to facilitate the creation of nail arts and nail protections in particular, an UV curing device capable of curing the nails of multiple fingers or toes all at once safely and effectively while simultaneously minimizing unnecessary exposure.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative examples, in which the principles of the disclosure are utilized, and the accompanying drawings of which:

FIG. 1 illustrates an exploded view of a UV LED curing apparatus, according to at least one instance of the present disclosure;

FIG. 2 illustrates a diagrammatic view of an inner casing assembly of a UV LED curing apparatus, according to at least one instance of the present disclosure;

FIG. 3 illustrates a diagrammatic view a UV LED curing apparatus having dual light sources, according to at least one instance of the present disclosure;

FIG. 4. illustrates a diagrammatic view a UV LED curing apparatus having dual light sources with one light source in a stored state, according to at least one instance of the present disclosure

### DETAILED DESCRIPTION

Examples and various features and advantageous details thereof are explained more fully with reference to the exemplary, and therefore non-limiting, examples illustrated in the accompanying drawings and detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or Bis satisfied by any one of the following: A is true (or present) and B is false (or not present), A is false (or not present) and Bis true (or present), and both A and Bare true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “for instance,” “e.g.,” “In some examples,” and the like.

The present disclosure is drawn to a dual source UV LED curing apparatus. The dual source UV LED curing apparatus can include a housing having an inner casing with a UV LED light source operably arranged therein and an outer casing having a second UV LED light source operably arranged thereon. The second UV LED light source can be coupled with an adjustable arm coupled with the outer casing at a proximal end and having the second UV LED light source disposed at a distal end thereof. A switch controller electrically connected to the UV LED light source and/or the second UV LED light source controlling an on-off state of the UV LED light source and/or the second UV LED light source.

The inner casing can have a plurality of planes formed at one or more reflective angles with at least one LED module, of a plurality of LED modules associated with the UV LED light source, arranged on two or more planes.

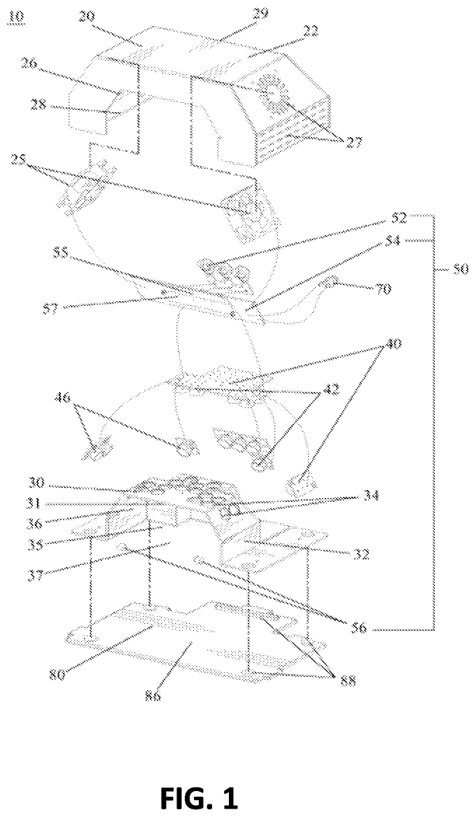

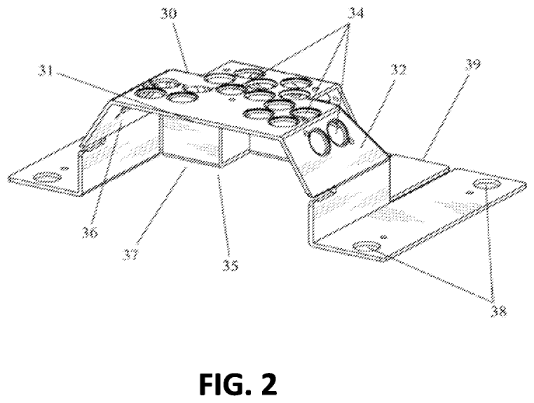

FIGS. 1 and 2 illustrate a UV LED curing apparatus, according to at least one instance of the present disclosure. The UV LED curing apparatus 10 can provide UV LED light of desired wavelength(s) to objects applied with an UV hardening gel, in particular, such gel applied to the nails of one or more fingers and/or toes placed or received within the apparatus. The UV LED curing apparatus can be operable to transform a liquid-phase gel to a solid-phase layer, thus forming a coating over the nail upon which the gel was applied. In at least one instance, the UV LED curing apparatus 10 can include a light reflective inner casing 30 having a light reflective inner wall 36 enclosing an inner chamber 35 and an outer wall 32; wherein the inner chamber 35 (e.g. curing chamber) includes at least one front opening 37 facing toward a front side of the apparatus 10 and an outer casing 20 detachably attached to the outer wall 32 of the inner casing 30 via fixation means 28 such as screws, bolts and/or magnets. The inner casing 30 can advantageously serve as both a light reflector and/or a supporting substrate for a UV LED light source 40. The detachable outer casing 20 can be provided to advantageously allow greater user interactions for entertainment purposes in addition to being a protective layer for components of the UV LED curing apparatus 10 including, but not limited to UV LED light source 40.

The UV LED light source 40 can include a plurality of UV LED modules 42 affixed to the inner casing 30 and having a light emitting side D facing toward the inner chamber 35 thereof. The plurality of UV LED modules 42 can be preferably attached to the outer wall 32 of the inner casing 30. The inner casing 30 can have a plurality of apertures 34 formed and operable to receive said UV LED modules 42 therein, such that the light emitting side D of the UV LED module 42 can be positioned corresponding to these apertures 34 and thus allowing UV light emitted from the UV LED modules 42 to be directed toward the inner chamber 35 of the inner casing 30.

In at least one instance of the present disclosure, the UV LED light source can be of a short wavelength between approximately 360 nm and approximately 460 nm. In a more specific instance of the present disclosure, the UV LED module 42 of the light source 40 can be pre-selected to be approximately 405 nm. In other instances, the UV LED module 42 of the light source 40 can be between approximately 620 nm and approximately 700 nm, corresponding to a red light wavelength. In other instances, the UV LED light source can be any wavelength, in the visible and/or non-visible spectrum, operable to correspond to a predetermined curing wavelength.

One or more of the plurality of UV LED modules 42 of the UV LED light source 40 can include a collimator 46 attached to the light emitting side D thereof to facilitate the focus and/or direction of the UV light emitted therefrom. In at least one instance of the present disclosure, the collimator 46 can be a plano-convex lens having a convex light output surface to direct UV light entered. The UV LED module and/or LED emitter can be a lamp-type LED, SMD-type LED and/or can-type LED. It is within the scope of the present disclosure that other UV LEDs capable of curing an UV hardening gel such as acrylic gel can be used. The UV hardening gel can transform from a liquid-like state to a solid state while being exposed to UV rays; in addition, the UV LED hardening gel can undergo such phase change of solidification within 30 seconds of time subject to the UV LED light.

According to at least one instance of the present disclosure, the inner casing 30 of the UV LED curing apparatus 10 can be formed of a plurality of surfaces as shown in FIG. 2. The inner wall 36 of the inner casing 30 can include a plurality of planes angled from one another such that the UV light can be reflected and/or directed within the inner chamber 35 to provide a desired illumination. The plurality of UV LED modules 42 can be disposed on one or more planes of the inner wall 36, thus providing multiple lighting angles within the inner chamber 30. In at least one instance of the present disclosure, the UV LED modules 42 can be evenly arranged across the plurality of planes. In other instances of the present disclosure, the UV LED modules 42 can be arranged in a predetermined pattern across the plurality of planes to maximize efficiency of the UV LED light source 40, while reducing unnecessary exposure. The UV LED modules 42 can be arranged such that one or more planes of the plurality of planes can have more UV LED modules 42 than other planes of the plurality of planes. In at least some instances, one or more planes of the plurality of planes can have no UV LED modules 42 arranged thereon.

The planes can be angled from one another at an angle between about 90 degree and about 175 degree. In at least one instance, the angle between any two adjacent planes thereof can be about 120 degree, such that the UV LED modules 42 of the UV LED light source 40 having a light emitting side D facing toward the inner chamber 35 of the inner casing 30 can provide an uniform illumination in the inner chamber 35. In other instances, the angle between any two adjacent places can be different angles between about 90 degree and about 175 degree depending on the size and/or shape of the inner chamber 35.

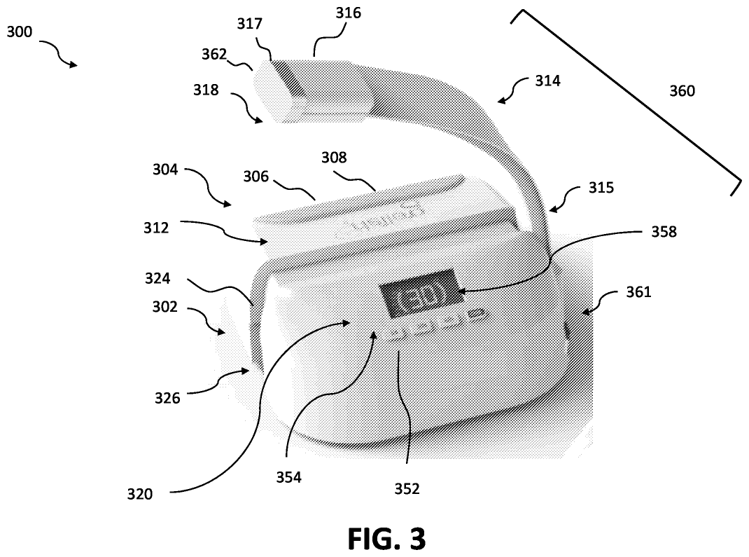

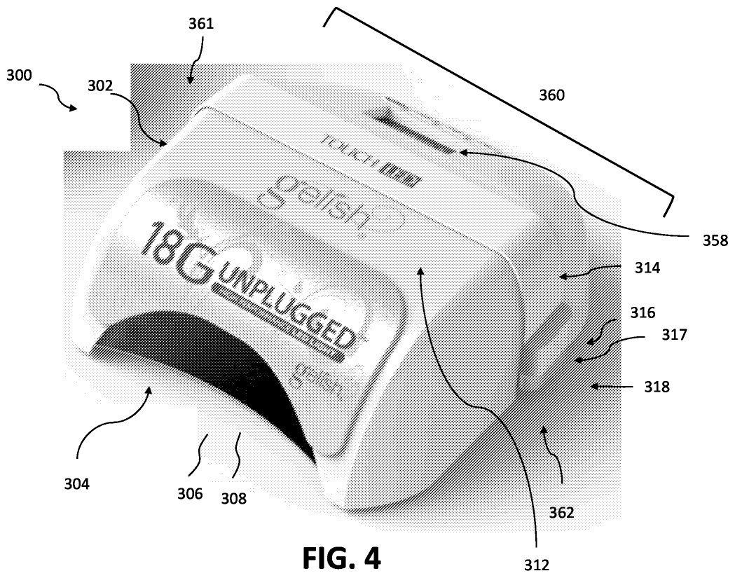

As shown in FIG. 2, the outer casing 20 of the apparatus can be provided as a protective means and/or a decorative means detachably attached to the inner casing 20. The outer casing 20 can further comprise at least one heat dissipater 25 disposed between the outer casing 20 and the inner casing 30 operable to dissipate heat generated by the UV LED light source 40 away therefrom. In at least one instance, the heat dissipator 25 can be a rotary fan electrically connected to a switch controller 50 and activated by said first input signal from a photo interrupt module thereof, such that the rotatory fan can be activated upon detection of a user placing an object within the inner chamber 35. The outer casing 20 can be further provided with one or more heat dissipating vents 27 to facilitate the air flow therethrough. The one or more heat dissipating vents 27 can include a plurality of slots, apertures, and/or other shape operable to facilitate airflow. The one or more heat dissipating vents 27 can be arranged in predetermined locations on the outer casing 20 to provide optimal heat dissipation. In at least one instance, the outer wall 22 of the outer casing can include a flat top to allow user resting hands or feet thereon, especially, during the application and curing of the UV hardening gel applied onto the nails of the fingers or toes. As discussed in more detail below with respect to FIGS. 3-4, a second LED light source 60 operable to assist in curing and/or hardening the UV hardening jail while a user rests a hand and/or foot thereon.

The inner wall 26 can be further provided with one or more attachment elements 28, including, but not limited to, magnets, operable to facilitate attachment to the inner casing 30. The one or more fixation elements 28 can be provided on the outer casing to facilitate the attachment to the inner casing 20 via for example screws, bolts and/or magnets. According to at least one instance of the present disclosure, the outer casing 20 can further include a bottom cover 80 having one or more fixation elements 88 detachably attached to the inner casing 30 via for example screws, bolts, and/or magnets. In other instances, the bottom cover 80 can be detachably attached to the outer casing 20 via the inner casing 30, in particular via the fixation elements 38 of the inner casing 30. The fixation elements 38 can also be through holes (e.g. apertures) such that the outer casing 20 can be attached to a bottom cover 80 directly. In still another instance, the upper surface 86 of the bottom cover 80 can also include a reflective surface and/or can be further coated with a reflective material or metal alloys such as silver, nickel, cobalt, aluminum and/or combinations thereof to facilitate the reflection of the UV light within the inner or curing chamber 35 of the inner casing 30 or housing.

The UV LED curing apparatus 10 can also include a switch controller 50. The switch controller 50 can further include at least one button 52, a substrate 54, and a photo interrupt module 56. The switch controller 50 can be attached to the inner casing 30 and electrically connected to the UV LED light source 40. Furthermore, the substrate 54 of the switch controller can further include a timer 55 and/or a current regulator 57 integrated thereon and electrically connected to the photo interrupt module 56. The buttons 52 can be start button and/or press buttons electrically connected to the substrate 52 and/or the photo interrupt module 56 can be photo sensors having an emitter and a receiver to detect an interrupt signal.

In at least one instance of the present disclosure, the at least one buttons 52 and/or the substrate 52 are preferably arranged on a rear side of the inner casing 30 and provided on a rear side of the apparatus 10. The photo interrupt module 56 can be arranged adjacent to the front opening 37 of the inner casing 30. It can be understood that the photo interrupt module 56 can too be provided on any location or spot of the inner wall 36 of the inner casing 30 and preferably within the inner chamber 35 and operably arranged to detect an interrupt signal triggered by for example the insertion of user's hand or foot into the inner chamber 35 via the front opening 37 thereof.

The substrate 54 can include a timer 55 and/or a current regulator 57 integrated thereon to control of an on-off state of the UV LED light source 40 electrically connected thereto. With reference to FIG. 2, the sensor emitter and/or receiver of the photo interrupt module 56 is attached to the inner casing 30 and positioned at the lateral sides of the front opening 37 thereof for detection of interrupt signal. It can be understood that the photo interrupt module 56, can possibly include more than one sensors, which can be provided on any location or spot of the inner chamber 35 of the inner casing 30 to detect an interrupt signal.

To enhance the portability of the UV LED curing apparatus 10, in at least one instance, the UV LED curing apparatus 10 can further comprise a power supply 70 . The power supply 70 can be for example include one or more rechargeable batteries (and/or battery cells) electrically connected to the UV LED light source 40 and/or the switch controller 50 of the apparatus. The power supply 70 can be attached to the inner casing 30 and enclosed by the outer casing 20. In instances, the power supply 70 can include both an electrical plug for direct AC power connection and/or DC rechargeable batteries.

The power supply 70 can include one or more ports operable to allow the UV LED curing apparatus to function as a powerbank, and thus transfer power to one or more accessory devices. The one or more accessory ports can allow, for example, charging a personal electronic device, a charging and/or powering a electronic nail file, or the like.

FIG. 3 illustrates a dual source UV LED curing apparatus 300 according to at least one instance of the present disclosure. The dual source UV LED curing apparatus 300 can have a housing 302 having an inner chamber 304 formed therein. The inner chamber 304 can be operable to receive at least a portion of user's hand and/or foot therein. The dual source UV LED curing apparatus 300 can include at least one UV LED light source 306 coupled therewith and the UV LED light source 306 can include a plurality of UV LED modules 308 with at least one UV LED module 308 arranged within the inner chamber 304 of the housing 302, as detailed with respect to FIGS. 1-2. In at least one instance, the UV LED light source 306 can include at least one UV LED module 310 arranged exteriorly and adjacent to the housing 302 of the UV LED curing apparatus 300, thereby providing a second LED light source. In some instances, the dual source UV LED curing apparatus 300 can include a second UV LED light source 316 having a second plurality of UV LED modules 318 arranged exterior and adjacent to the housing 302.

The housing 302 can include a rest point 312 operably arranged on an exterior surface and configured to receive a portion of a user's hand and/or foot thereon. The rest point 312 can be a substantially flat and/or contoured surface operable to receive at least a portion of the user's hand and/or foot. The rest portion 312 can include a pad and/or textured surface to provide ergonomic support for the user. In at least one instance, the rest point 312 includes a pad and/or textured surface molded to receive and/or support fingers and/or toes thereon. In other instances, the housing 302 can have two rest points 312 operable to receiver fingers and toes, respectively.

The dual source UV LED curing apparatus 300 can include at least two distinct UV LED light sources 306, 316 locations including one UV LED light source 306 location in the inner chamber 304 of the housing 302 and one UV LED light source 316 location exterior to the housing 302. The two distinct UV LED light sources 306, 316 locations can be linked to a single switch controller 320 and/or individual switch controllers 320 for each UV LED light source 306, 316 location, respectively. The housing 302 can include at least one rest point 312 proximal to the exterior UV LED light source 316 location, thereby allowing UV LED curing to occur outside of the inner chamber 304.

As can be specifically appreciated in FIG. 3, the UV LED source 316 arranged on an exterior surface of the housing 302 can be operably attached to the housing 302 by an adjustable arm 314. The adjustable arm 314 can be a multi-position and/or infinitely adjustable element extending away from the housing 302 and having a predetermined length 360. The adjustable arm 314 can be flexible, pivotable, and/or adjustable, thus allowing a user to manipulate its shape, angle, and/or position while having sufficient rigidity to independently maintain a desired position without user input. In at least one instance, the adjustable arm 314 has a flexible metal core surrounded by a polymer providing a softer feel for user engagement. In some instances, the flexible metal core can also be covered by a polished metal, and/or a series of metal rings (e.g. such as a tightly wound coil spring).

In other instances, the adjustable arm 314 can include a plurality of nodes 315 coupled together, the plurality of nodes 315 each pivotably and/or rotatably relative to an adjustable node. The plurality of nodes 315 can have a pressure and/or interference fit, thus providing a predetermined number of pivot points, but providing sufficient friction at each node to independently maintain a desired position relative to an adjacent node.

In at least one instance of the present disclosure, the adjustable arm 314 can be extendable and/or retractable, thus allowing adjustment of the predetermined length 360. The extension and/or retraction of the adjustable arm 314 can include a telescoping and/or sliding arrangement between one or more nodes 315. In at least one instance, the adjustable arm 314 can be operable in an extending position, a retracted position, or in any position therebetween. In yet other instances, the adjustable arm 314 can be operable an extended position and non-operable in a retracted position, thus preventing incidental activation during storage or transport.

The predetermined length 360 of the adjustable arm 314 can extend from a proximal end 361 adjacent to the housing 302 to a distal end 362 of the adjustable arm 314. The distal end 362 of the adjustable arm 314 can have the second UV LED light source 316 coupled therewith. The second UV LED light source 316 can be disposed at the distal end 362 and have a second plurality of UV LED modules 318 arranged thereon. The UV LED light source 316 and the second plurality of UV LED modules 318 can be operably coupled with a touch-sensitive button 317 disposed on the UV LED light source 316. The touch-sensitive button 317 can transition the UV LED modules 318 between one or more operational states. The one or more operational states can include an on/off state, a higher light-output state, a lower light output state, a wider light output state, a narrower light output state, and/or a variable light output state. The variable light output stage can include, but is not limited to, variance in the brightness, wavelength, light distribution, and can include a predetermined pattern or oscillation therebetween and/or a random or variable pattern or oscillation therebetween. In at least one instance of the present disclosure, the one or more operational states can corresponding to an operational arrangement of the plurality of second UV LED modules 318 including operating each of the plurality of second UV LED modules 318 (e.g. “higher light output state”), a portion of the plurality of second UV LED modules 318 (e.g. “lower light output state”), a predetermined arrangement of the plurality of second UV LED modules 318 operable to induce a wider light output (e.g. “wider light output state”) relative to a second predetermined arrangement of the plurality of second UV LED modules 318 operate to provide a narrower light output (e.g. “narrower light output state”). The touch-sensitive button 317 can be operable to control the second UV LED light source 316 independent of the function of the UV LED light source 306.

The adjustable arm 314 can also be coupled with and/or de-couplable from the UV LED curing apparatus 300, thus allowing the interchange and/or interoperability of a plurality of adjustable arms 314 and/or associated UV LED light source(s) 316. The adjustable arm 314 and/or the associated UV LED light source 316 can be modularly coupled with the UV LED curing apparatus 300. The UV LED curing apparatus 300 can allow modular coupling with, for example, an adjustable arm 314 having a fan, UV LED light source producing a different wavelength (e.g. red light), a whitening light, and/or the like. This can allow a user and/or operator of the UV LED curing apparatus 300 to adjust the functionality of the UV LED curing apparatus 300 through a treatment or throughout the course of a day without having to have multiple devices.

In other instances, the second UV LED module 316 can further be controllable by the switch controller 320 and/or one or more buttons 352 associated therewith.

The second plurality of UV LED modules 316 can be disposed in a predetermined pattern at the distal end 362 to maximize effectiveness and efficiency of the second UV LED light sourced 316. In some instances, the second plurality of UV LED modules 318 can be arranged to minimize a uniform light angle, thus providing a localized light pattern operable to cover one or more fingers or toes and preventing light bleed to adjacent areas. In other instances, the second plurality of UV LED modules 318 can be arranged to provide a wide light pattern operable to provide coverage across a hand and/or foot. The second plurality of UV LED modules 318 can include a photo-interrupt module and/or motion sensor operable to detect placement of an object (e.g. user's hand or foot) within a predetermined proximity of the second plurality of UV LED modules 318.

As can be appreciated in FIG. 3, the switch controller 320 can be operable arranged on the housing 302. In at least one instance of the present disclosure, the switch controller 320 can further include at least one button 352, a substrate 354, and/or a photo interrupt module 356 (shown in FIG. 4). The switch controller 320 can be electrically connected to the UV LED light source 306 and/or the second UV LED light source 316. The switch controller 320 can include one or more LED displays 358 operable to communicate one or more operational elements to a user including, but not limited to, power source, battery status, time remaining, UV LED light source 306, 316 operation status, and/or the like. the one or more LED displays 358 can include backlighting and/or monochromatic and color elements.

The one or more buttons 352 can be press-button, touch pads, touch sensitive buttons, switches, and include a start button, predetermined time period buttons, and/or one or more press buttons electrically connected to the substrate 354. As can specifically be appreciated in FIG. 3, the one or more buttons can include a predetermined light illumination periods (e.g. 5 seconds, 30 seconds, 60 seconds, etc.) and/or on/off buttons. In other instances, the one or more buttons can include a first plurality of buttons associated with the UV LED light source 306 and a second plurality of buttons associated with the second UV LED light source 316. The first plurality of buttons and the second plurality of buttons can be communicatively coupled with the switch controller 320, and/or can be communicatively coupled with independent switch controllers, respectively.

The UV LED curing apparatus 300 can have one or more grooves 324 formed in an exterior surface of the housing 302. The one or more grooves 324 can correspondingly shaped and operable to receive at least a portion of the adjustable arm 314 and/or the second UV LED light source 316 therein. The second UV LED light source 316 can be pivoted and/or adjusted to fit within the one or more grooves 324 when non-operable and/or during storage or transport. The one or more grooves 324 can be formed across one or more surfaces of the exterior of the housing 302 including, but not limited to, the top surface, left surface, right surface, and/or the rear surface.

FIG. 4 illustrates a UV LED curing apparatus having a second UV LED light source in stored arrangement, according to at least one instance of the present disclosure. The second UV LED light source 316 can be stored and/or otherwise positioned within the one or more grooves 324 in a storage arrangement during transport and/or when non-operational.

The one or more grooves 324 can be operable to substantially accommodate the predetermined length 360 of the adjustable arm 314 and the second UV LED light source 316 therein.

As can be appreciated in FIG. 4, in a stored arrangement the adjustable arm 314 and/or the second UV LED light source 316 can be received within the one or more grooves 324 and form a substantially flush outer surface with the housing 302. The one or more grooves 324 can provide a smooth outer surface of the housing 302 when the second UV LED light source 316 is in the stored arrangement. The stored arrangement can provide the UV LED curing apparatus 300 with a clean appearance and compact design during storage and/or transport.

In at least one instance of the present disclosure, the one or more grooves 324 can have a latch mechanism 326 operable to secure the adjustable arm 314 and/or second UV LED light source 316 therein. The latch mechanism 326 can operably engage with a portion of the adjustable arm 314 and/or the second UV LED light source 316, thereby maintaining the second UV LED light source 316 in a stored configuration. The latch mechanism 326 can operably implement a pressure fit arrangement, a biased catch mechanism, magnetic engagement, a push-button engagement, and/or other engageable elements operable to secure the second UV LED light source 316.

During the curing operation, user can place his or her hand or foot in the inner chamber of the UV LED curing apparatus of the present invention such that the UV hardening gel, such as acrylic type UV gel, applied onto multiple nails can be cured and solidified. As the apparatus is electrically connected to the power supply and at an initial on-state, the photo interrupt of the switch controller is also preferably activated and stayed on at an “active mode” continuous for a certain period of listening time preset by the abovementioned timer and current regulator of the switch controller, waiting to receive an interrupt signal or first input signal to be sent and triggered by the external user's action of insertion into the inner chamber of the apparatus. The failure to receiving any interrupt signal from the photo interrupt module triggered by the user during such preset period of listening time in the active mode, the switch controller can set the apparatus to be at an inactive state or “standby mode” that can only be re-activated by a start signal received from a start button. Once the user hand or foot is inserted into the apparatus and the interrupt or first input signal is triggered or sent from the photo interrupt, the switch controller then sets the apparatus to be at a “curing mode” and simultaneously, the UV LED light source is being activated to an on-state by the switch controller to shine UV light within the inner chamber.

According to one preferred embodiment of the present invention, the timer and the current regulator of the switch controller also include a preset period of curing time such that the UV LED light source can be controlled and turned to an off-state automatically with reference to such preset of curing time as a time-up signal or second input signal is sent by the timer and the current regulator of the switch controller to off the UV LED light source, ensuring an efficient and safe curing of the apparatus. Once the curing time lapses and the time-up signal is received, the switch controller sets the apparatus to turn to the abovementioned active mode again waiting for another interrupt signal to be triggered and sent by the photo interrupt module. In other words, the switch controller provides an automatic control of the UV LED curing apparatus of the present invention such that the apparatus can be activated automatically following user's insertion of hand or toe applied with an UV hardening gel on the nails thereof into the curing chamber or inner chamber and the UV light from the UV LED light source can be turned off automatically once the preset curing time lapses.

While preferred examples of the present disclosure have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

1. A UV LED curing apparatus, comprising:
an inner casing having a plurality of planes formed at a reflective angle, one from the other;
an outer casing detachably attached to the an outer surface of the inner casing; the outer casing and the inner casing defining a space suitable for receiving an ultraviolet (UV) light emitting diode (LED) light source, wherein the UV LED light source includes a plurality of LED modules, at least one LED module arranged on two or more planes of the plurality of planes;
an adjustable arm pivotally coupled with the outer casing at a proximal end and extending a predetermined distance to a distal end, a second UV LED light source including a second plurality of LED modules coupled with the distal end of the adjustable arm;
a switch controller electrically connected to the UV LED light source and/or the second UV LED light source, the switch controller controlling an on-off state of the UV LED light source and/or the second UV LED light source.

2. The UV LED curing apparatus of claim 1, wherein the outer casing includes one or more grooves therein.

3. The UV LED curing apparatus of claim 1, wherein at least a portion of the adjustable arm and/or the second UV LED light source is configured to be received within the one or more grooves.

4. The UV LED curing apparatus of claim 1, further comprising a second switch controller operably coupled with the second UV LED light source and/or the second plurality of LED modules.

5. The UV LED curing apparatus of claim 1, wherein the second UV LED light source includes a touch-sensitive button and/or motion sensor controlling an on-off state of the second UV LED light source.

6. The UV LED curing apparatus of claim 1, wherein the touch sensitive button transitions the second UV LED light source between a plurality of operational statuses.

7. The UV LED curing apparatus of claim 1, wherein the plurality of operational statuses include an on status, an off status, a high light output status, a low light output status, a wide light output status, and/or a narrow light output status.

8. The UV LED curing apparatus of claim 1, wherein the outer casing includes a latching mechanism operable to engage with a portion of the adjustable arm and/or the second UV LED module in a stored state.

9. The UV LED curing apparatus of claim 1, wherein the latching mechanism is magnetic and/or press-fit engagement.

10. The UV LED curing apparatus of claim 1, wherein the switch controller includes a substrate having a timer and/or a current regulator, the timer and/or current regulator operable to transmit a signal to the switch controller to transition the UV LED light source and/or the second UV LED light source light source to the off state.

11. The UV LED curing apparatus of claim 1, wherein the switch controller further includes at least one button.

12. The UV LED curing apparatus of claim 1, wherein the UV LED light source and/or the second UV LED light source is of a short wavelength between 360 nanometers (nm) and 460 nm.

13. A UV LED curing system, comprising:
an inner casing having a plurality of planes formed at a reflective angle, one from the other;
an outer casing detachably attached to the an outer surface of the inner casing; the outer casing and the inner casing defining a space suitable for receiving an ultraviolet (UV) light emitting diode (LED) light source, wherein the UV LED light source includes a plurality of LED modules, at least one LED module arranged on two or more planes of the plurality of planes;
an adjustable arm pivotally coupled with the outer casing at a proximal end and extending a predetermined distance to a distal end, a second UV LED light source including a second plurality of LED modules coupled with the distal end of the adjustable arm;
a switch controller electrically connected to the UV LED light source and/or the second UV LED light source, the switch controller controlling an on-off state of the UV LED light source and/or the second UV LED light source;
a power supply electrically coupled to the UV LED light source and/or the second UV LED light source.

14. The UV LED curing system of claim 13, wherein the power supply is one of alternating current (AC), direct current (DC), or battery power.

15. The UV LED curing system of claims 13, wherein the power supplies includes one or more rechargeable battery cells.
